(19) United States
(12) Patent Application Publication
(10) Pub. No.: US 2013/0257157 A1
(43) Pub. Date: Oct. 3, 2013

(54) APPARATUS AND METHOD FOR SOALR COMPATIBLE GREEN POWER SUPPLY

(71) Applicant: Jack J. Sun, Palo Alto, CA (US)

(72) Inventor: Jack J. Sun, Palo Alto, CA (US)

(21) Appl. No.: 13/436,663

(22) Filed: Mar. 30, 2012

(51) Int. Cl. H02J 9/00

(52) U.S. Cl. 307/64

(57) ABSTRACT

An apparatus and method for green power supply unit (gPSU) that uses solar PV power as primary input source and grid utility power as backup source, provides seamless power to load is disclosed. In one embodiment, the invention can be retrofitted or mounted easily for a system such as non-mobile computer, and ultimately utilize clean energy, and aim to reduce the consumption of traditional grid power which usually involves environmental concerns.

### FIELD OF THE INVENTION

This invention relates to the design of green power supply unit (gPSU) that can take solar PV power input directly . The present invention relates particularly to the methods that make the solar PV power as primary energy source, and grid power as backup source, and provide seamless output under sunny or cloudy weather conditions.

### BACKGROUND OF THE INVENTION

Inside a digital device such as computer server, there is at least one power supply unit (PSU), which takes high voltage AC power (such as 110V 50 Hz) from grid and transform into low voltage DC power(such as 12V DC).

Patent application Ser. No. 13/372,479 described a method that solar PV power can be used by a computer server and eliminate or bypass traditional PSU. However in real world, there are always days without sunshine and during those days grid power must be used to support critical load like data centers computers operation.

### SUMMARY OF THE INVENTION

This invention presents the method and apparatus for a green power supply that uses solar power as primary source and grid power as backup source, handling all seasons, and provide seamless power to critical load like data centers.

### BRIEF DESCRIPTION OF THE DRAWINGS

FIG. 1 illustrates the function of prior typical computer power supply unit (PSU).

FIG. 2 shows the function of green power supply unit (gPSU) of the invention.

FIG. 3 shows one embodiment by implements the principle of the Invention, which can be easily retrofitted or mounted for a system in use.

### DETAILED DESCRIPTION OF THE DRAWINGS

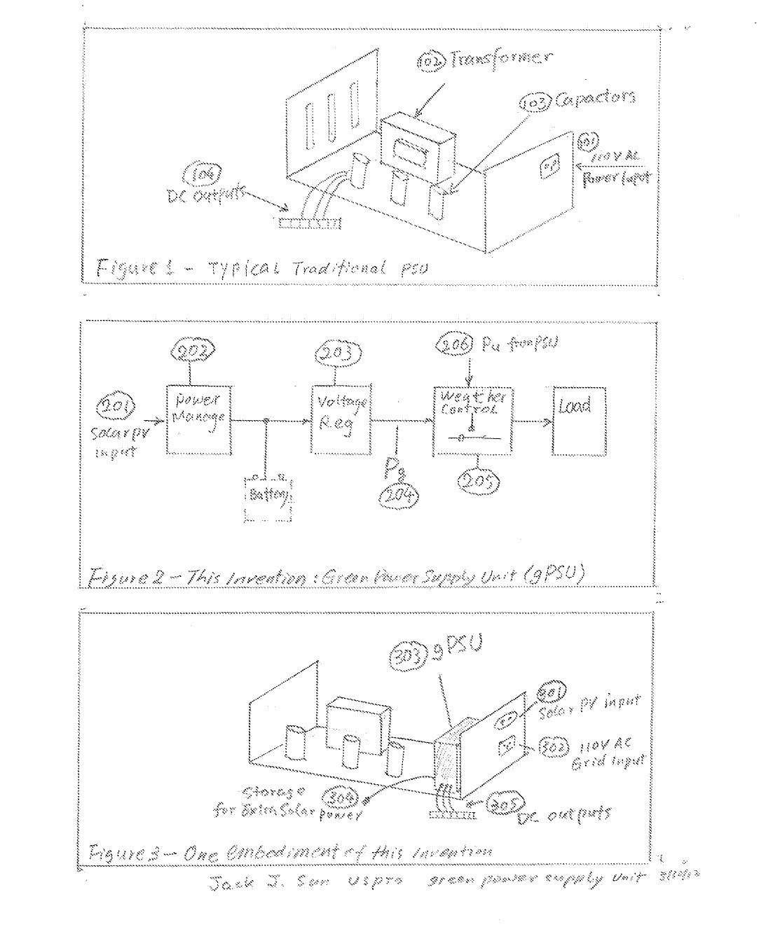

FIG. 1 shows a current typical power supply unit (PSU). Input 110V or 220V AC utility power 101 will be converted into output 104 as standard low voltage DC power for load, Transformer 102, Electrolytic capacitor 103 are key components of PSU.

FIG. 2 shows the Green Power Supply Unit (gPSU) in this invention, to seamlessly handle all weather conditions and provide non-stop power to critical loads. Solar PV input 201 is usually below 50 V DC, varies during a day and seasons. Power management 202 provide optimized power and store extra power (into battery), Voltage Regulator 203 stabilize voltage output 204; weather control 205 makes decision when there is not enough power Pg 204, then connect utility PSU Pu 206 to load.

FIG. 3 shows one embodiment by implement the principle of the invention, which can be easily retrofitted or mounted for a system in use. Female plug 301 takes in solar PV power, plug 302 takes in the utility wall power, green power supply 303 outputs 305 DC to load, and output 304 will send extra solar power into storage.

What is claimed is:

1. A method comprising:
A green power supply system that uses solar PV DC power as the primary input source and grid utility high voltage AC power as backup input source, and provide seamless low voltage DC power output to load.
